(19) United States
(12) Patent Application Publication
(10) Pub. No.: US 2013/0339094 A1
(43) Pub. Date: Dec. 19, 2013

(54) SYSTEM AND METHOD FOR INCLUDING AND EXCLUDING SPECIFIC COMPARABLES

(71) Applicants: Megan C. Berry, Rockville, MD (US); Herbert F. Frymark, JR., Gaithersburg, MD (US); Felix G. Meale, North Bethesda, MD (US); Eric Rosenblatt, Derwood, MD (US); Dwayne D. Seegars, Columbia, MD (US)

(72) Inventors: Megan C. Berry, Rockville, MD (US); Herbert F. Frymark, JR., Gaithersburg, MD (US); Felix G. Meale, North Bethesda, MD (US); Eric Rosenblatt, Derwood, MD (US); Dwayne D. Seegars, Columbia, MD (US)

(73) Assignee: Fannie Mae, Washington, DC (US)

(21) Appl. No.: 13/495,604

(22) Filed: Jun. 13, 2012

(51) Int. Cl. G06Q 30/02

(52) U.S. Cl. 705/7.34

(57) ABSTRACT

A system and method for automatically accessing property data corresponding to properties within the geographic area and displaying on a display device a map corresponding to said geographic area. Applying a comparable selection model based on a subject to the property data to generate a set of comparable properties, altering the set of comparable properties based on a variation command to generate an altered comparable property set, and displaying on the display device the map with the altered comparable property information.

### BACKGROUND OF THE INVENTION

1. Field of the Invention

This application relates generally to an automated valuation model (AVM) to rank and display comparables for a subject property, and more particularly to including and excluding comparables from displayed rankings.

2. Description of the Related Art

Automated valuation models (AVM) have been developed to estimate property values. However, a typical AVM performs estimations based upon predetermined inflexible geographical data sets. This may not be especially useful for particular applications.

For example, the sales comparison approach of real estate valuation relies heavily on the definition of neighborhood (i.e. a geographic area from which relevant comparable sales to the subject can be identified). An incorrectly-defined neighborhood would either miss relevant comparable sales or include irrelevant comparables sales (or both) and lead to inaccurate valuations.

Traditional AVM models have implemented fixed geographical standards to define the area subject to automated valuation. Thus, AVM systems that accommodate a more tailored approach to property value estimations are needed.

### SUMMARY OF THE INVENTION

The present invention relates to comparable property analysis. In one example, this comprise displaying on a display device a map image corresponding to a geographic area, accessing property data corresponding to properties within the geographical area, applying a comparable selection model to generate a set of comparable properties for a subject property, altering the set of comparable properties based on a signal to generate an altered comparable property set, and displaying the map image including the altered comparable property set.

The described may be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the described are more fully disclosed in the following specification, reference being had to the accompanying drawings, in which:

FIG. 1 is a flow diagram illustrating an example of a comparable property analysis process;

FIGS. 2A-B are block diagrams illustrating examples of a comparable property analysis application;

FIGS. 3A-B are block diagrams illustrating examples of a system in which a comparable property analysis application including a customized neighborhood determination application operates;

FIG. 4 is a display diagram illustrating an example of a geographic filter designation interface; and

FIG. 5 is a flow diagram illustrating an example of a comparable property analysis process.

### DETAILED DESCRIPTION OF THE INVENTION

In the following description, for purposes of explanation, numerous details are set forth, such as flowcharts and system configurations, to provide an understanding of one or more embodiments. However, it is and will be apparent to one skilled in the art that these specific details are not required to practice the described invention.

The present invention provides an automated valuation model (AVM) to rank and display comparables for a subject property using a comparable property analysis application. Further, in a comparable selection model (CSM), comparable properties are selected based on their similarity to a subject. Next, whether through automatic manipulation or through user interaction, comparables from the displayed list are excluded from and comparable properties that were not originally included in the displayed list may be included in the AVM ranking calculations.

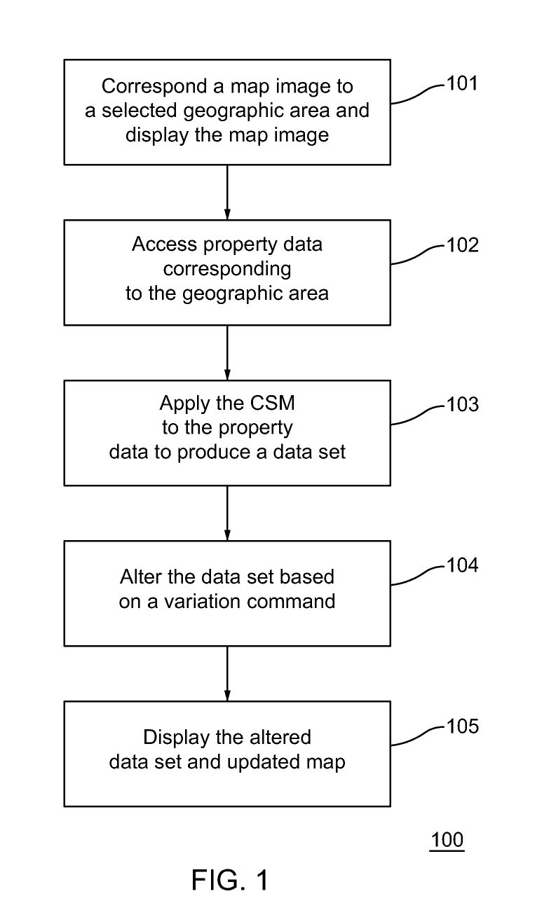

For example, FIG. 1 is a flow diagram illustrating an example of a comparable property analysis process 100. A map image corresponding to a geographic area is displayed 101 on a screen or display device. Property data corresponding to properties within the geographical area is accessed 102 and a CSM is applied 103 based on a subject property. The results (or set of comparable properties) of the CSM are then altered 104 by an automatic or a user generated signal (i.e. a variation command). The altered results (or altered comparable property set) are then displayed 105 on the screen within the map image and in a corresponding table along with AVM subject valuations. Further, properties that were included by the automatic or user generated signal may be displayed with their respective rank numbers that the CSM would have assigned (or that would have been produced by the AVM ranking calculations) regardless of the specific inclusion. Alternatively, comparable properties may be displayed with a ranking boosted by the specific inclusions.

Regarding the CSM, modeling and mapping appropriate comparable properties may comprise accessing property data corresponding to a geographical area, and then weighting comparable properties based upon the appropriateness of each of the plurality of comparable properties as comparables for a subject property. For example, the weighting may be based upon economic distance from the subject property, geographic distance from the subject property, and age of transaction. Using this information, a map image of the geographical area is displayed, with indicators on the map image for the subject property and corresponding comparable properties.

In one example, the property data is accessed and a regression models the relationship between price and explanatory variables. For example, a hedonic regression is performed at a geographic level (e.g., county) sufficient to produce reliable results. In the hedonic equation, the dependent variable is sale price and the explanatory variables can include the physical characteristics, such as gross living area, lot size, age, number of bedrooms, and number of bathrooms, as well as location specific effects, time of sale specific effects, property condition effect (or a proxy thereof). This is merely an example of one possible hedonic model, and an ordinarily skilled artisan will readily recognize that various different variables may be used in conjunction with the present invention.

In this example, the dependent variable is the logged sale price. The explanatory variables are (1) four continuous property characteristics: (a) log of gross living area (GLA), (b) log of Lot Size, (c) log of Age, and (d) Number of Bathrooms; and (2) three fixed effect variables: (a) location fixed effect (e.g., by Census Block Group (CBG)), (b) Time fixed effect (e.g., measured by 3-month periods (quarters) counting back from the estimation date), and (c) Foreclosure status fixed effect, which captures the maintenance condition and possible REO discount. The exemplary equation (Eq. 1) is as follows:

$$ln ( p ) = {β}_{gla} \cdot ln ( GLA ) + {β}_{lot} \cdot ln ( LOT ) + {β}_{age} \cdot ln ( AGE ) + {β}_{bath} \cdot BATH ++ {\sum }_{i = 1}^{{N}_{CBG}} {LOC}_{i}^{CBG} + {\sum }_{j = 1}^{{N}_{QTR}} {TIME}_{j} + {\sum }_{k = \{ 0 , 1 \}} {FCL}_{k} + ɛ \qquad ( Eq . 1 )$$

The above equation is offered as an example, and as noted, there may be departures. For example, although CBG is used as the location fixed effect, other examples may include Census Tract or other units of geographical area. Additionally, months may be used in lieu of quarters, or other periods may be used regarding the time fixed effect. These and other variations may be used for the explanatory variables. Additionally, although the county may be used for the relatively large geographic area for which the regression analysis is performed, other areas such as a multi-county area, state, metropolitan statistical area, or others may be used. Still further, some hedonic models may omit or add different explanatory variables.

Using the hedonic regression, a pool of comparable properties is identified, such as by initial exclusion rules based upon distance from and other factors in relation to a subject property. That is, comparable selection rules narrow the pool of comparable properties to exclude the properties which are determined to be insufficiently similar to the subject. A comparable property should be located in a relative vicinity of the subject and should be sold relatively recently; it should also be of similar size and age and sit on a commensurate parcel of land. The “N” comparables that pass through the exclusion rules are used for further analysis and value prediction. For example, the following rules may be used to exclude comparables pursuant to narrowing the pool:
(1) Neighborhood: comps must be located in the Census Tract of the subject and its immediate neighboring tracts;
(2) Time: comps must be sales within twelve months of the effective date of appraisal or sale;
(3) GLA must be within a defined range, for example:

$$\frac{2}{3} \leq \frac{{GLA}_{S}}{{GLA}_{C}} \leq \frac{3}{2} ;$$

(4) Age similarity may be determined according to the following Table 1:

TABLE 1

| | | | | | | | |
|---|---|---|---|---|---|---|---|
| Subject Age | 0-2 | 3-5 | 6-10 | 11-20 | 21-40 | 41-65 | 65+ |
| Acceptable Comp Age | 0-5 | 0-10 | 2-20 | 5-40 | 11-65 | 15-80 | 45+; |
| and | | | | | | | |

(5) Lot size similarity may be determined according to the following Table 2:

TABLE 2

| | | | | | | | |
|---|---|---|---|---|---|---|---|
| Subject | <2000 | sqft | 2000-4000 | sqft | 4000 sqft-3 acres | >3 | acres |
| Lot | | | | | | | |
| size | | | | | | | |
| Accept- able Comp Lot | 1-4000 | sqft | 1-8000 | sqft | $\frac{2}{5} \leq \frac{{LOT}_{s}}{{LOT}_{c}} \leq \frac{5}{2}$ | >1 | acre |

These exclusion rules are provided by way of example. There may be a set of exclusion rules that add variables, that omit one or more the described variables, or that use different thresholds or ranges.

A set of adjustments for each comparable is determined using adjustment factors drawn from the regression analysis. These adjustments are then used to derive an economic distance between each comparable and the subject property. For example, the economic distance may be a value indicative of the estimated price difference between a comparable property and the subject that is determined from the set of adjustments for that comparable property. The comparables are then weighted according to the economic distance, physical distance, and time (of sale) between the comparable and the subject property.

Regarding the automatic or user generated variation command (i.e. signal), the variation command may comprise a signal that directs the comparable property analysis process 100 to include comparable properties in the altered comparable property set that were not originally included in the set of comparable properties or that directs the comparable property analysis process 100 to exclude comparable properties included in the set of comparable properties from the altered comparable property set. Alternatively, the variation command may not specifically be the described inclusion/exclusion signal; rather, the variation command may be a prompt that offers or suggests comparable properties for inclusion and exclusion. In this case a user may review the automatic suggestion by the comparable property analysis process 100 and choose which comparable properties are acceptable for the ranking calculations by the AVM (or CSM).

In another embodiment, the comparable property analysis process 100 may employ a variation command that is directly linked to a zoom function of the map image where, when a user adjusts the map through a scrolling feature, click-zoom feature, or data entry feature (such as entering a zip code or city), the altered comparable property set automatically changes in accordance with the new geographic area displayed on the map image. Further, the variation command can be a direct selection command where a user directly selects individual properties from a map image and these properties are either excluded from or include in the altered comparable property set. Further, the variation command can be a drawing tool command where users draw a geometric or organic shape over a map image to select properties to be included in the altered comparable property set. That is, when a user creates or defines a boundary through a default shape tool, a free-hand sketch tool, or a combination of both, the comparable valuation model looks for comparable sales within the geographic area identified by the boundary. The user may alter the defined geographic area through a carve-in or -out mechanism that permits further shaping of portions of the defined boundaries. For example, after the comparable property analysis process 100 generates a set of comparable properties over a map image, a user may use drawing tool to form a geometric shape (e.g. square, circle, etc.) over the map image. The user may then alter the boundaries of the geometric shape to mimic streets or property boundaries. When the user is finished manipulating the geometric shape, the final boundaries will define which comparable properties are included in or excluded from the altered comparable property set.

Regarding the map image, a map image is displayed to illustrate the geographic distribution of the subject property and the comparable properties. Further, an associated grid or table details information about the subject and comparable properties. The table can be sorted according to a variety of property and other characteristics, and operates in conjunction with the map image to ease review of the comparables and corresponding criteria. The map image may be variously scaled (i.e. a zoom function) and updated to show the subject property and corresponding comparables in the viewed range while interacting with the table (e.g. cursor overlay on comparable property in the map image allows highlighting of additional data in the table). Similarly, the table can be directly updated based on the above described direct selection command.

Specifically, the map image and table are displayed on the display device. The table lists comparable properties from the altered comparable property set. The table includes rankings based upon how close the comparable property is to the subject according to the CSM (whether before or after variation). It is preferred that the rankings include a comparable rank and an altered rank for each comparable property listed in the table. The comparable rank is a comparable property's rank as originally generated by the CSM (or alternatively the AVM). That is, the CSM will rank comparable properties based on their appropriateness as comparables for a subject property (i.e. the higher the similarity or closeness to the subject relative to other comparable properties, the higher the rank) when the CSM initially selects the comparable for subject evaluation. In contrast, the altered rank is the rank of each comparable property after the variation command has been implemented on the original set of comparable properties selected by the CSM (i.e. similar to the comparable rank, the closeness to the subject relative to new set of other comparable properties equates to a higher rank). Therefore, using the table, a user can readily obtain how their choice (addition or subtraction of comparable properties) affects the AVM.

The table may further display different valuations. That is, a preferred AVM involves a regression based upon the above described property data, with the regression modeling the relationship between price and explanatory variables. Specifically, the method may apply the AVM to the subject with each property data set, such that the table may display the pre-variation command valuation, the post-variation command valuation, or both.

Refinement and assessment of potential comparables may also be optionally carried out. After a subject property and a plurality of comparable properties are identified (by the CSM and/or altered by the variation command), the AVM determines a set of value adjustments for each of the plurality of comparable properties based upon differences in the explanatory variables between the subject property and each of the plurality of comparable properties. Once the properties are identified and the adjustments are implemented, valuation calculations are performed.

A preferred way of implementing the above method for comparable property analysis is by using a terminal computer, with the above comparable property analysis application installed thereon. However, a terminal computer is not the only contemplated computer system. Any computer system, such as a laptop personal computer or a handheld portable computer (e.g., tablets, PDAs, cell phones, mobile phones, smart-phones, super-phones, and the like) may be used. Further, the functions described herein may be implemented on any conventional computing or electronic device, such as personal computer, conventional desktop computer, a network computer, or any of the various execution environments that will be readily apparent to the artisan and need not be named herein.

The computer system runs any conventional operating system through the interaction of the CPU (or GPU) and the memory to carry out the described functionality by execution of computer instructions. Operating systems may include but are not limited to iOS, Android, Windows, UNIX, Linux, Macintosh, or the like. The computer system may further implement applications that facilitate calculations. The memory may be any memory suitable for storing data, such as any volatile or non-volatile memory, whether virtual or permanent, or any other non-transitory computer readable medium (e.g., compact disk, hard disk, and the like). Preferably, the memory stores the comparable property analysis application, which comprises program code that is executable by the processor to perform operations in support of comparable property analysis. Therefore, the comparable property analysis application is preferably provided as software on the computer system described above, yet it may alternatively be hardware, firmware, or any combination of software, hardware, and firmware. Still other embodiments include computer implemented processes described in connection with FIGS. 1-5. Further, an artisan will readily recognize the various alternative programming languages and execution platforms that are and will become available, and the described is not limited to any specific execution environment.

Thus according to one aspect, the application includes program code stored on a non-transitory computer readable medium executable to perform operations of comparable property analysis including displaying, by a computer, on a display device of a map image corresponding to a geographic area; accessing, by the computer, property data corresponding to properties within the geographical area; applying, by the computer, a comparable selection model based on a subject to the property data to generate a set of comparable properties; altering, by the computer, the set of comparable properties based on a variation command to generate an altered comparable property set; and displaying, by the computer, on the display device the map image including the altered comparable property set.

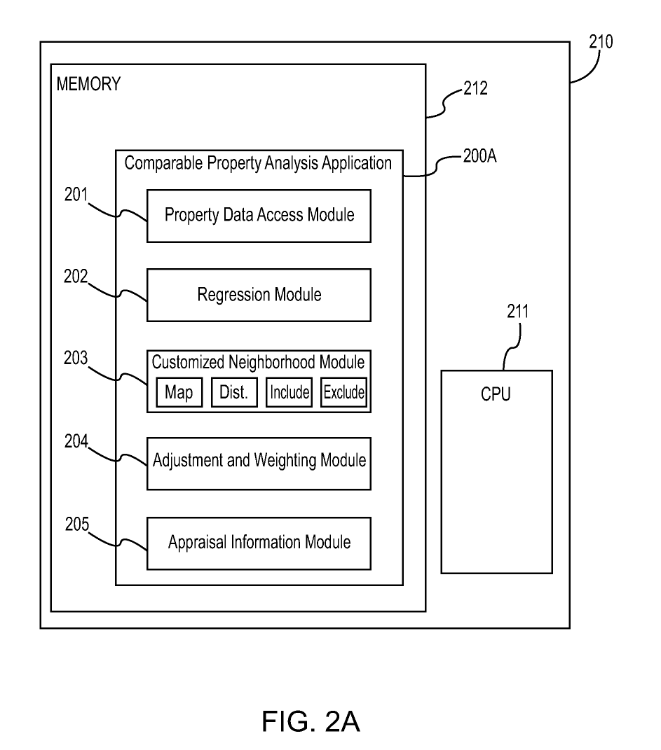

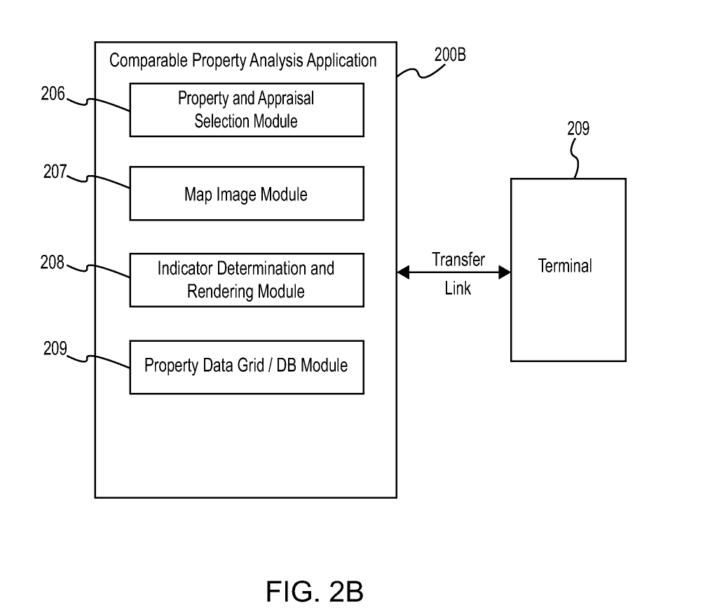

FIGS. 2A-B are block diagrams illustrating examples of a comparable property analysis application. Specifically, FIG. 2A is a block diagram illustrating an example of an electronic device 210 that comprises a comparable property analysis application 200A stored on a memory 212 and constructed from program code that is executable by a central processing unit (CPU) 211 to perform operations of a comparable property analysis process 100. Alternatively, the electronic device 210 may be any of the computer systems described above, and further the comparable property analysis application 200A may be implemented in any of the systems (350A and 350B) described below. Further, the comparable property analysis application 200A is preferably provided as software, but may alternatively be provided as hardware or firmware, or any combination of software, hardware and/or firmware.

The application 200A is configured to provide the automated valuation modeling and comparable property selection, modeling, and mapping functionality described herein. Although one modular breakdown of the application 200A is offered, it should be understood that the same functionality may be provided using fewer, greater, or differently named modules. The example of the application 200A of FIG. 2A includes a property data access module 201, a regression module 202, a customized neighborhood module 203, an adjustment and weighting module 204, and an appraisal information module 205. And although it is not shown, the application 200A further includes a user interface module and an application programmable interface module; however, these modules may be integrated with any of the above named modules.

The property data access module 201 includes program code for carrying out access to and management of the property data, whether from internal or external resources.

The regression module 202 includes program code for carrying out the regression upon the accessed property data, according to the regression algorithm described herein, and produces corresponding results such as the determination of regression coefficients and other data, as appropriate for a subject property. The regression module 202 may implement any conventional code for carrying out the regression given the described explanatory variables and property data.

The customized neighborhood module 203 includes program code for neighborhood customization and corresponding valuation. The customized neighborhood module 203 provides interfaces for receiving input pursuant to defining a geographic area to provide custom identification of a neighborhood subject to automated valuation. This allows the user to interact with the map image to provide appropriate input to generate a shape or the like that defines the geographic area that in turn identifies the customized neighborhood. Once the neighborhood is defined, the CSM is applied to identify the best comparable properties for a subject property within the defined geographic area. Accordingly, the map image can be updated (i.e. by the map image module 207 described below) to display the comparable properties, typically along with the subject property, along with indication of the defined geographic area/neighborhood on the map image. Examples of defining the neighborhood include inclusion, exclusion, distance, tract and display as described elsewhere herein.

The adjustment and weighting module 204 is configured to apply the exclusion rules, and to calculate the set of adjustment factors for the individual comparables, the economic distance, and the weighting of the comparables.

The appraisal information module 205 may be a stand-alone database or may organize access to a variety of external databases of appraisal information. The appraisal information is typically in the form of appraisal reports for subject properties, wherein a set of comparable properties chosen by an appraiser is listed. The appraisal information may be retrieved based upon a variety of criteria, including searches by subject property, identification number, or characteristics (appraiser ID, vendor, date, etc.). In addition, the appraisal information module 205 may work in conjunction with the property data access module 201 to retrieve and produce the property data for the application 200A.

The user interface module includes program code for managing the display and receipt of information from a user to provide the described functionality. The user interface module permits user management of the results of the CSM and AVM. Further, the user interface module permits the application 200A to be displayed in a map, menu, icon, tabular, or grid format, with various functional representations according to a module's required functionality. That is, the user interface is configured to provide mapping and analytical tools that implement the comparable property analysis application's mapping features. For example, a prompt that offers or suggests comparable properties for inclusion or exclusion may be displayed, such that a user may review the automatic suggestions by the comparable property analysis application 200A and choose which comparable properties are acceptable for a ranking calculation. Additionally, a table or grid of data may concurrently be displayable so that a user can readily obtain the comparable and altered ranks. The table view allows the user to sort the list of properties based on of the above defined property characteristics, rankings, or any other dimensions. The rows in the table may be connected to the full database entry through the property data access module 201 and the appraisal information module 205, as well as the related additional market resources 320 defined below. Combined with the map view, this allows for a convenient yet comprehensive interactive analysis of comparable properties.

The application programmable interface module is configured to communicate directly with other applications, modules, models, devices, and other sources through both physical and virtual interfaces. The application programmable interface module manages the dispatching and receipt of information in relation to the above sources and sources external to the application along with integrating the application 200A with other applications and drivers, as needed per operating system.

FIG. 2B is a block diagram illustrating an example of a comparable property analysis application 200B that is external to a terminal 209, which accesses the functionality of the comparable property analysis application 200B. That is, a user device or a smartphone may act as a terminal 209 where through either web browsing or mobile application technology the application 200B is configured to run in the functional context of a server or host. Further, the application 200B at least includes a property and appraisal selection module 206, a map image access module 207, an indicator determination and rendering module 208, and a property data grid/DB module 209. Furthermore, the application 200B may include any of the other modules listed in FIG. 2A. Again, it should be understood that the same functionality may be provided using fewer, greater, or differently named modules.

In FIG. 2B, the property and appraisal selection module 206 includes program code for managing the interfaces and input used to identify one or more subject properties and corresponding appraisal information, as well as ranking the plurality of comparable properties based upon the weighting and displaying a text listing of the plurality of comparable properties according to said rankings. Further, the property and appraisal selection module 206 works with the user interface module to perform said management functionality.

The map image module 207 includes program code for accessing mapping functions for displaying a map image corresponding to the geographical area and managing the depiction of the map images indicative of the subject property and at least one of the plurality of comparable properties, as well as the capability to display the boundaries of a geographic area based on a received input pursuant to defining a custom neighborhood. Further, the map image module 207 may display the subject property and corresponding properties within the defined geographic area with demarcations of the defined geographic area (i.e., highlighted boundaries) as the neighborhood of interest. The neighborhood may be defined by inclusion within a user-defined shape, exclusion of a user-defined shape from a previously defined geographic area, the set of properties within a given distance from a subject property, properties corresponding to a tract or adjacent tracts, or properties currently displayed on a map image (which may be manipulated as desired, prior to user indication to lock in the defined area).

The indicator determination and rendering module 208 is configured to manage which indicators should be indicated on the map image depending upon the current map image, the weighted ranking of the comparables, and predetermined settings or user input.

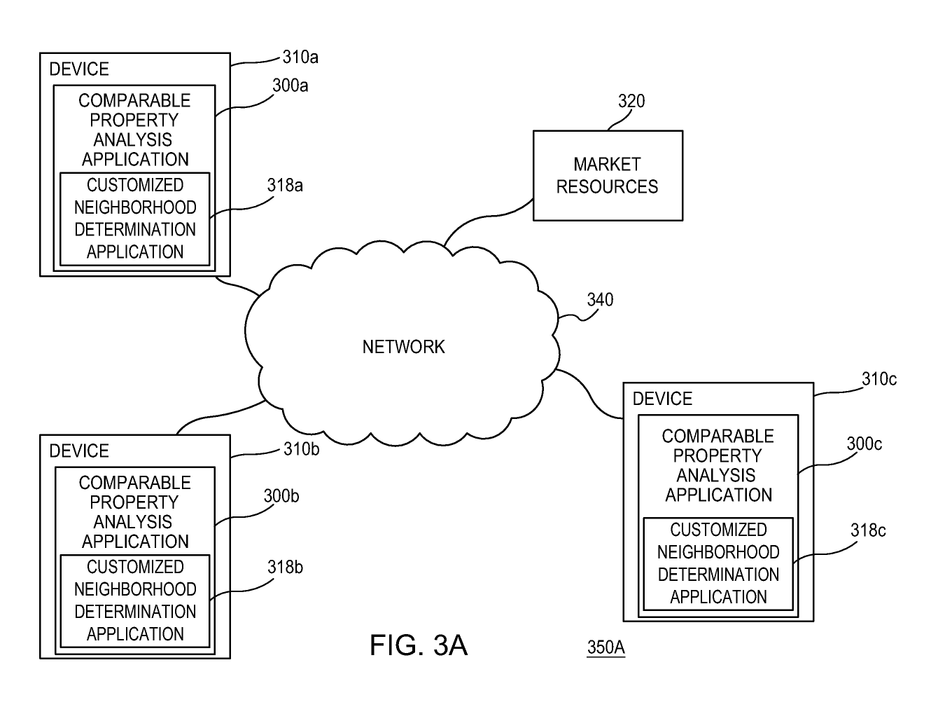

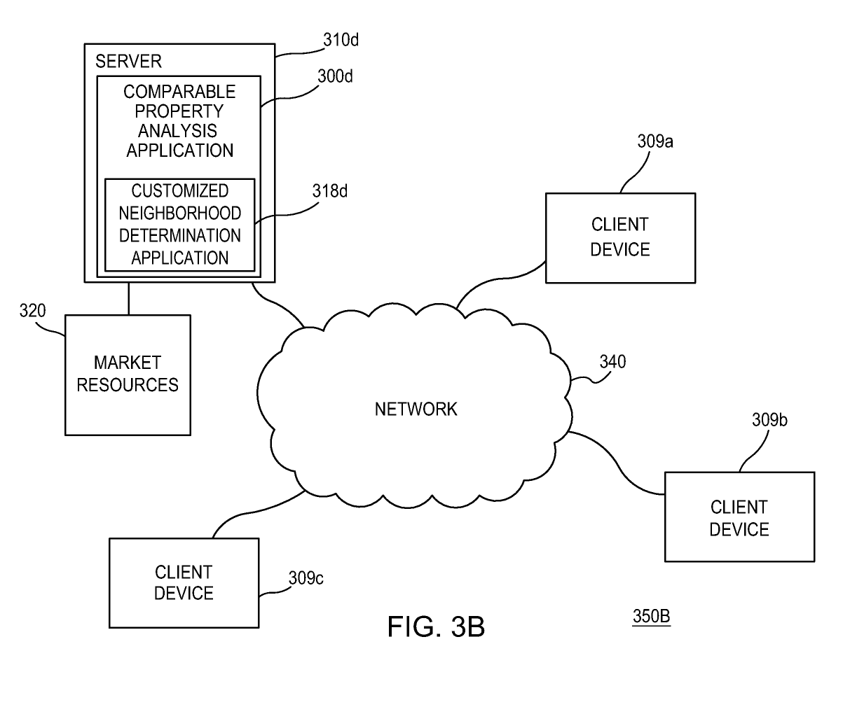

The property data grid/DB module 209 includes program code for managing the data set corresponding to a current session, including the subject property and pool of comparable properties. It is configured as a database that allows the property data for the properties to be displayed in a tabular or grid format, with various sorting according to the property characteristics, economic distance, geographical distance, time, etc. Note, each above describe module and its functionality is further described in connection with FIGS. 3-5 below.

FIGS. 3A-B are block diagrams illustrating examples of a system in which a comparable property analysis application including a customized neighborhood determination application operates. Specifically, FIG. 3 is block diagram illustrating an example of a system 350A in which the comparable property analysis applications 300a-c including customized neighborhood determination applications 318a-c operate. FIG. 3A further illustrates several devices 310a-c, each having the comparable property analysis applications 300a-c installed thereon (see also FIG. 2A-B). The devices 310a-c are preferably terminal computers, but may alternatively be any of the computer systems described above.

Similarly, the network 340 over which the devices 310a-c (through their interfaces, which are not shown) communicate is preferably a local area network; however, it may alternatively be any conventional networking technology. For instance, the network may be any of the technologies of cellular network, global area network, wireless local area networks, wide area networks, local area networks, or combinations thereof, but is not limited thereto. Further, the interfaces of the devices 310a-c may be any interface suited for input and output of communication data, whether that communication is visual, auditory, electrical, transitive, or the like.

FIG. 3B is an alternative where client devices 309a-c may respectively access a device 310d (see also FIG. 2A-B), preferably through direct application linking, with the device 310d providing the comparable property analysis application 300d including the customized neighborhood determination application 318d for access by the client devices 309a-c. In this embodiment, the device 310d is preferably a server providing application access to and computing power for use by client devices 309a-c (i.e. terminal computers with the comparable properties analysis application not installed thereon). For example, the user devices 309a-c may be configured with a web browser application, with the comparable property analysis application 300d configured to run in the context of the functionality of the browser application. This configuration may also implement a network architecture wherein the user devices 309a-c provide, share, and rely upon the comparable property analysis application 300d functionality. This would reduce the resource requirements on the client devices and enhance efficiency of the system 350B. However, as another alternative, the functionality of the comparable property analysis application 300d may be divided between the client devices 309a-c and the server 310d, where the functions may be located separately on any device and accessed through distributed computing, such that the functionality is provided for, shared, and relied upon by other devices. Finally, of course, a single computing device may be independently configured to include the entire functionality of the comparable property analysis application 300d.

Additionally, as illustrated in FIGS. 3A-B, market resources 320 are shown as a singular block in the figure, but it should be understood that the singular block represents a variety of resources, including financial intuition databases, MLS listings, GIS data, or resources compiled by an information services provider (e.g. tax assessors, other appraising services, and the like). Further, market resources 320 are typically accessed externally for use by the applications, since the amount of property data is rather voluminous, and since the application is configured to allow access to multiple loan databases and multiple auto resource databases. The application accesses and retrieves the market data from these resources in support of comparable property analysis.

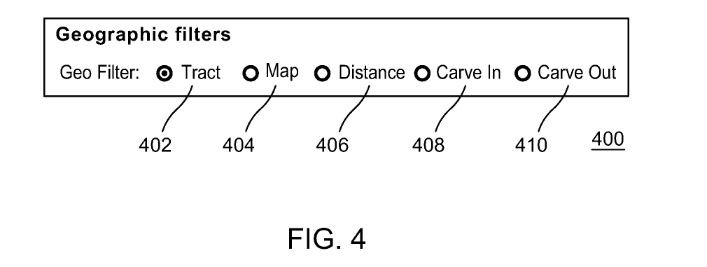

FIG. 4 is a display diagram illustrating an example of a geographic filter designation interface. Specifically, FIG. 4 is a display diagram illustrating an example of the geographic filter designation interface 400, with Tract 402, Map 404, Distance 406, Carve In 408, and Carve Out 410 indicated. The interface 400 allows selection of the corresponding modes through which the geographic areas will be defined.

Under the “Tract” mode, the comparable property analysis application will look for comparable sales in a Census Tract of the subject property, and all contiguous Census Tracts. Because the Census Bureau has tried to identify homogenous areas in the process of defining the Census Tract, this mode is believed to provide an easy but effective method of identifying relevant comparable sales to be used in valuation model.

In the “Map” mode, the comparable property analysis application will rank and display comparable properties from the set dictated by the geographical area shown in a map window. The map window can be manipulated (zoom in, zoom out, move) using conventional commands prior to an indication to identify the current map image as the defined geographic area.

In the “Distance” mode, the comparable valuation model will look for comparable sales within a distance of the subject property. The distance may, for example, be input by the user.

In the “Carve In” mode, the comparable valuation model looks for comparable sales within the defined geographic area.

Finally, in the Carve Out” mode, the comparable property analysis application looks for comparable sales, excepting as candidates the properties within the defined geographic area.

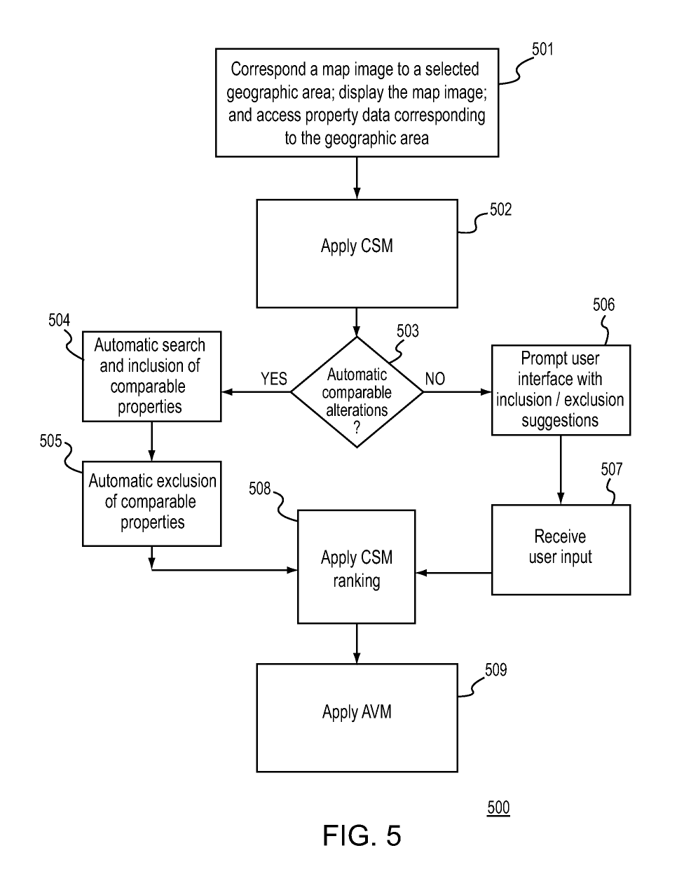

FIG. 5 is a flow diagram illustrating an example of a comparable property analysis process. Specifically, FIG. 5 is a flow diagram illustrating an example of the comparable property analysis process 500 that describes one possible operation sequence for the applications 200A and 200B.

Specifically, the comparable property analysis process 500 begins by corresponding 501 a map image to a geographic area that is displayed on a screen or display device while accessing property data corresponding to properties within the displayed geographical area. The comparable property analysis process 500 then applies 502 a CSM based on a subject, such that comparable properties appropriate to a subject are selected and ranked. In other words, the comparable property applications 200A and 200B using the property data access module 201, the regression module 202, the map image module 207, and other various modules generate a map image displaying comparable properties appropriate to a subject.

The results or set of comparable properties (i.e. the comparable properties appropriate to the subject) of the CSM will then be altered automatically or by a user. Specifically, the comparable property analysis process 500 first displays a prompt that checks 503 if a manual opt-out is initiated. For instance, after the CSM is applied 502 to the geographic area for property selection, the process displays a prompt that indicates a count down where after a predetermined time (i.e. 10 seconds) an automatic comparable alteration (YES) by the comparable property analysis process 500 is initiated. After the automatic comparable alteration is initiated, the process steps through two different variation commands. One variation command is an inclusion command where comparable properties that were not included in the original set of comparable properties selected by the CSM are searched 504. If comparable properties that were not included in the original set of comparable properties selected by the CSM and that should be included in the AVM calculation are identified by the process 500, then those properties may be added in the altered comparable property set for later ranking (i.e. included when a second ranking 508 is performed) and subject valuation. Another variation command is an exclusion command where comparable properties included in the set of comparable properties are excluded 505 from the altered comparable property set. Thus, these excluded properties will be subtracted from the altered comparable property set when the second ranking and subject valuation are performed. Although inclusion 504 and exclusion 505 appear consecutively, these automatic alterations may be performed in reverse order, in the alternative, or simultaneously. Further, the constraints under which inclusion 504 and exclusion 505 operate may be varied to capture comparable properties unique to individual valuation sessions. That is, a user may prefer automatic inclusion 504 and exclusion 505 providing they can define the constraints that the process 500 operates under. For example, a user may want to alter the property characteristic thresholds or neighborhood boundaries that the process 500 uses when performing inclusions 504 and exclusions 505. Thus, the user may interrupt the timer by selecting (NO), manually set constraints under a user prompt, and then return to the automatic include 504 and exclude 505 process.

Alternatively, users may interrupt the timer by selecting (NO) a manual opt-out to initiate specific variation commands. Thus, the process proceeds to prompt 506 the user for user variation commands while displaying a recommendation of a set of properties to be included 504 and excluded 505. The recommendation is an optional setting under the manual input mode. The user may then input specific variation commands in many different forms. For example, a user may alter the original set of comparable properties by direct selection of individual properties or in accordance with a zoom function that renders a new geographic area, as described above.

Once the process receives 508 the user specific variation commands and/or the automatic included 504 and excluded 505 alterations, the process generates an altered comparable property set based on the received commands and alterations and applies 508 the CSM to rank the altered comparable property set. In addition, the process may loop through the user specific variation commands and the automatic alterations as many times as necessary to generate the most appropriate the altered comparable property set. After applying 508 the CSM to rank the altered comparable properties set, the comparable property analysis process 500 applies 509 the AVM to the property data and the subject. The altered results (or altered comparable property set) are then displayed (see 105 of FIG. 1) on the map image and corresponding table along with the AVM valuations of the subject. Further, properties that were included by the automatic or user generated variation command may be displayed with the rank number the CSM would have assigned regardless of the specific inclusion.

Embodiments of the described produce and provide methods and apparatus for a model for providing real-time location-based promotions to a vehicle purchaser without the need for additional post-purchase decision conversations and signing ceremonies. Although the described is detailed considerably above with reference to certain embodiments thereof, the invention may be variously embodied without departing from the spirit or scope of the invention. Therefore, the following claims should not be limited to the description of the embodiments contained herein in any way.

1. A method for comparable property analysis, comprising:
accessing property data corresponding to a set of properties within a geographic area;
applying a comparable selection model to the property data to generate a set of comparable properties for a subject property and to assign an original ranking to the set of comparable properties, the comparable selection model utilizing a hedonic regression and applies exclusion rules to the property data;
altering the set of properties to produce an altered set of properties and separately applying the comparable selection model a second time to the altered set of properties to generate an updated set of comparable properties and an updated ranking that is specific to the altered set of properties; and
displaying a list of the updated set of comparable properties, including the original ranking and the updated ranking for each property in the list.

2. The method of claim 1,
wherein altering the set of properties comprises executing an inclusion command that produces the altered set of properties by introducing additional properties not included in the set of properties.

3. The method of claim 1,
wherein altering the set of properties comprises executing an exclusion command that produces the altered set of properties by removing properties from the set of properties.

4. The method of claim 1,
wherein altering the set of properties comprises executing a drawing tool command that produces the altered set of properties by including properties within a shape drawn on a map.

5. The method of claim 1, further comprises:
automatically suggesting comparable properties to be included in or excluded from the set of comparable properties and altering the set of comparable properties based on the suggesting comparable properties.

6. The method of claim 1, further comprising:
adjusting the altered set of properties in accordance with properties residing in a displayed map image,
wherein an update of the map image automatically updates the altered set of properties.

7. The method of claim 1, further comprising:
displaying contemporaneously with a map image a table listing comparable properties from the altered set of properties,
wherein the table includes the original ranking and the updated ranking for each comparable property listed in the table.

8. (canceled)

9. (canceled)

10. The method of claim 1, further comprising:
displaying contemporaneously with a map image a table listing comparable properties from the altered set of properties,
wherein altering the set of properties comprises executing a direct selection command that identifies individual properties within the geographic area for exclusion from or inclusion in the altered set of properties.

11. The method of claim 10, further comprising:
wherein the table is automatically updated based on the direct selection command.

12. A computer program product stored on a non-transitory computer readable medium that when executed by a computer performs comparable property analysis operations, comprising:
accessing, by the computer, property data corresponding to a set of properties within a geographic area;
applying, by the computer, a comparable selection model to the property data to generate a set of comparable properties for a subject property and to assign an original ranking to the set of comparable properties, the comparable selection model utilizing a hedonic regression and applying exclusion rules to the property data;
altering, by the computer, the set of properties to produce an altered set of properties and separately applying the comparable selection model a second time to the altered set of properties to generate an updated set of comparable properties and an updated ranking that is specific to the altered set of properties; and
displaying, by the computer, a list of the updated set of comparable properties, including the original ranking and the updated ranking for each property in the list.

13. (canceled)

14. The method of claim 1, wherein altering the set of comparable properties comprises:
including in the altered set of properties comparable properties not included in the set of comparable properties; and
excluding from the altered set of properties comparable properties included in the set of comparable properties.

15. The computer program product of claim 12, wherein altering the set of comparable properties comprises:
including in the altered set of properties comparable properties not included in the set of comparable properties; and
excluding from the altered set of properties comparable properties included in the set of comparable properties.

16. The method of claim 1, wherein the exclusion rules applied by the hedonic regression narrow to the property data based on an acceptable age similarly or an acceptable lot size similarity to the set of comparable properties for a subject property.

17. The computer program product of claim 12, wherein the exclusion rules applied by the hedonic regression narrow to the property data based on an acceptable age similarly or an acceptable lot size similarity to the set of comparable properties for a subject property.
